(19) United States
(12) Patent Application Publication
(10) Pub. No.: US 2025/0291115 A1
(43) Pub. Date: Sep. 18, 2025

(54) THERMALLY TUNABLE PHOTONIC CIRCUIT

(71) Applicant: X Development LLC, Mountain View, CA (US)

(72) Inventors: XAVIER SEREY, Santa Clara, CA (US); YI-KUEI RYAN WU, San Jose, CA (US)

(21) Appl. No.: 19/071,087

(22) Filed: Mar. 5, 2025

Related U.S. Application Data
(60) Provisional application No. 63/565,934, filed on Mar. 15, 2024.

(51) Int. Cl. G02B 6/293

(52) U.S. Cl. CPC G02B 6/2938; G02B 6/29395

(57) ABSTRACT

A thermally regulated photonic system includes a photonic component, a sensor adapted to measure a temperature related to the photonic component or a power output of the photonic component and generate a sensor value that is indicative of the temperature or the power output, a heat distribution system thermally coupled to the photonic component and adapted to generate and distribute heat to the photonic component, and a controller coupled to the sensor and the heat distribution system in a feedback loop configuration to thermally regulate the photonic component based upon the sensor value.

### CROSS REFERENCE TO RELATED APPLICATIONS

This application claims the benefit of U.S. Application No. 63/565,934, filed on Mar. 15, 2024, the contents of which are incorporated herein by reference.

### TECHNICAL FIELD

This disclosure relates generally to photonic devices, and in particular but not exclusively, relates to a thermally tunable inverse designed photonic integrated circuits such as optical multiplexers or demultiplexers.

### BACKGROUND INFORMATION

Fiber-optic communications are typically employed to transmit information from one place to another via light that has been modulated to carry the information. For example, many telecommunication companies use optical fiber to transmit telephone signals, internet communications, and cable television signals. But the cost of deploying optical fibers for fiber-optic communication may be prohibitive. As such, techniques have been developed to more efficiently use the bandwidth available within a single optical fiber. Wavelength-division multiplexing is one such technique that bundles multiple optical carrier signals onto a single optical fiber using different wavelengths.

Multiplexers (muxes) and demultiplexers (demuxes) are important system components that enable wavelength-division multiplexing. The performance of a photonic mux/demux is dependent upon temperature as the refractive index of most optical materials is temperature dependent. Designing a mux/demux to achieve a desired performance across all operational temperatures can be challenging. Across different temperatures, the mux/demux spectra and transmission parameters will shift. Conventionally, muxes and demuxes are engineered to be tolerant to wavelength shifts, but this engineering does not come for free and typically entails acceptance of performance losses. A mux/demux structure that is capable of maintaining a specified temperature across various operational demands may be desirable. Extending this capability to other types of photonic components and photonic integrated circuits may also be desirable.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1 illustrates how the spectral response of a 1×4 demultiplexer (demux) changes as the demux heats up during operation, in accordance with an embodiment of the present disclosure.

FIG. 2 is a functional block diagram illustrating a thermally regulated photonic system, in accordance with an embodiment of the disclosure.

FIG. 3A illustrates an optical receiver that includes thermally tunable demuxes having a control feedback loop based on monitoring temperature, in accordance with an embodiment of the present disclosure.

FIG. 3B illustrates an optical receiver that includes thermally tunable demuxes having a control feedback loop based on monitoring optical power, in accordance with an embodiment of the present disclosure.

FIG. 4A is a cross-sectional illustration depicting a photonic integrated circuit (PIC) having an inverse designed photonic component that is thermally regulated using a heat distribution network integrated with the PIC and positioned adjacent to the inverse designed photonic component, in accordance with an embodiment of the disclosure.

FIG. 4B is a cross-sectional illustration depicting a PIC having an inverse designed photonic component using a heat distribution network that is disposed in the inverse designed photonic component, in accordance with an embodiment of the disclosure.

FIG. 4C is a cross-sectional illustration depicting a PIC having an inverse designed photonic component that is thermally regulated using a heat distribution system that is partially integrated into the PIC, in accordance with an embodiment of the disclosure.

FIGS. 5A-C illustrate example routing patterns for the paths of a heat distribution network, in accordance with an embodiment of the disclosure.

FIG. 5D is a cross-sectional illustration of how the heat distribution network may be disposed adjacent to an inverse designed photonic component within a PIC, in accordance with an embodiment of the disclosure.

FIG. 5E is a cross-sectional illustration of how the heat distribution network may be disposed within and intersect with the inverse designed photonic component, in accordance with an embodiment of the disclosure.

FIG. 5F is a plan view illustration of how the heat distribution network may be disposed within and intersect with the inverse designed photonic component, in accordance with an embodiment of the disclosure.

FIG. 5G is a plan view illustration of how the heat distribution network may follow portions of a pattern of the inverse designed photonic component that correlate to high optical energy density locations, in accordance with an embodiment of the disclosure.

FIG. 6A illustrates a demonstrative simulated environment describing a photonic integrated circuit, in accordance with an embodiment of the present disclosure.

FIG. 6B illustrates an example operational simulation of a photonic integrated circuit, in accordance with an embodiment of the present disclosure.

FIG. 6C illustrates an example adjoint simulation within the simulated environment by backpropagating a loss value, in accordance with an embodiment of the present disclosure.

FIG. 7A is a flow chart illustrating example time steps for operational and adjoint simulations, in accordance with an embodiment of the present disclosure.

FIG. 7B is a chart illustrating a relationship between gradients determined from an operational simulation and an adjoint simulation, in accordance with an embodiment of the present disclosure.

FIG. 8A is a flow chart illustrating how the photonic floorplan of the inverse designed photonic component and the heater floorplan of the heat distribution system may be iteratively and jointly inversely optimized together, in accordance with an embodiment of the present disclosure.

FIG. 8B is a flow chart illustrating how the photonic floorplan of the inverse designed photonic component and the heater floorplan of the heat distribution system may be separately but sequentially optimized, in accordance with an embodiment of the present disclosure.

### DETAILED DESCRIPTION

Embodiments of a system, apparatus, and method of design and operation for a thermally regulated photonic system are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

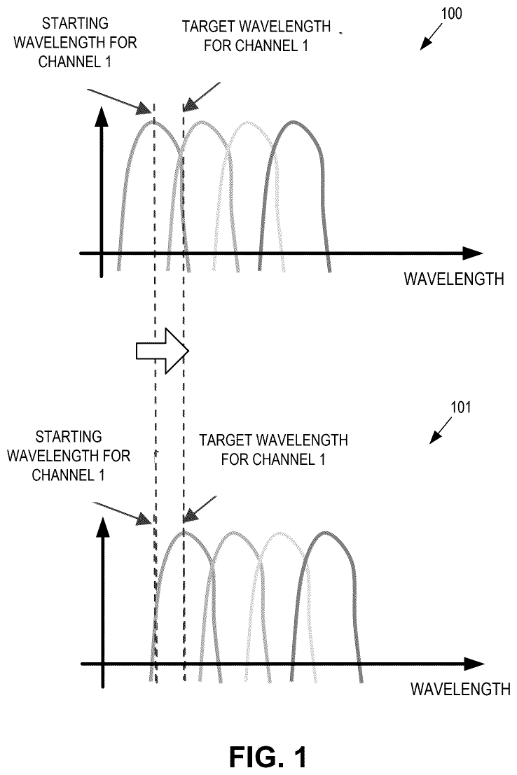

During operation of a photonic component, such as a demultiplexer (demux) or multiplexer (mux), the spectral response of such devices changes as the photonic component heats up during operation. FIG. 1 includes charts 100 and 101 illustrating this heat induced wavelength shift for an example 1×4 demux. Chart 100 illustrates how the four wavelengths each start at initial positions and then move to target positions as the demux reaches its steady-state target operational temperature. Embodiments described herein use a heat distribution system to thermally regulate a photonic component to a desired operating temperature and then hold that temperature to ensure the spectral response of the photonic component is optimally maintained.

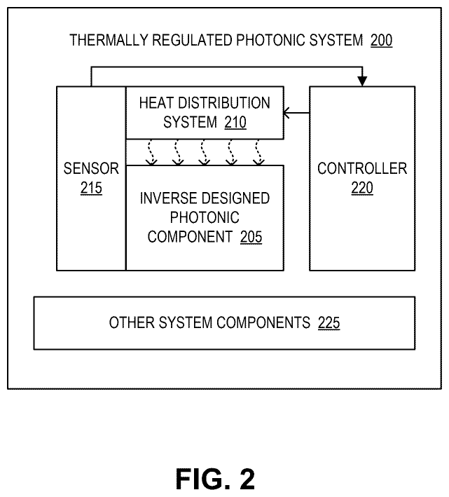

FIG. 2 is a functional block diagram illustrating a thermally regulated photonic system 200, in accordance with an embodiment of the disclosure. The illustrated embodiment of thermally regulated photonic system 200 includes an inverse designed photonic component 205, a heat distribution system 210, a sensor 215, a controller 220, and other system components 225. The illustrated system 200 may be fully integrated into a photonic integrated circuit (PIC), such as integration onto a silicon-on-insulator (SOI) substrate, or one or more subcomponents may be disposed external to the PIC and coupled therewith.

Inverse designed photonic component 205 is a photonic device, such as a mux, demux, splitter/combiner, polarization rotator, etc. that is designed to operate within a specified steady-state temperature range. During operation, heat distribution system 210 heats up and then maintains the operational temperature of inverse designed photonic component 205. Heat distribution system 210 includes a heater/driver coupled with a heat distribution network to evenly, or in a targeted manner, disperse heat to inverse designed photonic component 205. The operational temperature of inverse designed photonic component 205 may be directly measured, or indirectly inferred, from sensor 215, which along with heat distribution system 210 is coupled in a feedback loop configuration with controller 220.

Embodiments disclosed herein are described in connection with an inverse designed photonic component 205 and even an inverse designed heat distribution system 210. The design and optimization of physical devices, such as electromagnetic devices (e.g, antennas, waveguides, etc.), photonic devices (e.g., lasers, LEDs, waveguides, muxs/demuxs, etc.), fluidic devices, or acoustic devices, can be approached as an inverse problem where a designer provides a target specification and then determines a design that satisfies it. This target specification can be formalized and explicitly described in terms of a loss function L, where the convention L≤0 signifies that the target performance parameters have been achieved. The inverse problem, then, consists of finding a structural design z, which satisfies L≤0 or otherwise minimizes L using an iterative optimization approach. In contrast, the corresponding “forward problem” is one where the performance of a given design, relative to the target specification, needs to be determined for a given guess and check design. While the embodiments disclosed herein are described in connection with an inverse designed photonic component 205, it should be appreciated that the thermal regulation techniques are also applicable to traditionally designed photonic components integrated into PICs.

Thermally regulated photonic system 200 may include other peripheral/system components (represented as other system components 225) also integrated into a PIC, such as edge couplers, photodetectors, power regulation circuitry, control logic, etc. As mentioned, the entire system may be fully integrated into a single PIC, or one or more components (e.g., power/driver circuitry) may be externally disposed from the PIC and thermally or electrically coupled thereto. For example, the PIC may be packaged into a chip and a current driver or heater may be included within the packaged of the chip, but disposed external to the PIC that includes thermally regulated photonic system 200.

In one embodiment, sensor 215 is a type of thermometer (e.g., thermocouple) that is disposed within the PIC adjacent to inverse designed photonic component 205 to directly measure its temperature. In another embodiment, sensor 215 may be an optical power sensor (e.g., photodiode) adapted to measure output power of inverse designed photonic component 205, which is then correlated to an operational temperature or operational wavelength. In yet another embodiment, sensor 215 may be configured to measure the temperature of heat distribution system 210. During steady-state operation, the temperature relationship between the heat distribution system 210 and inverse designed photonic component 205 may be characterized and that relationship used to manage the operating temperature of inverse designed photonic component 205 by measuring the temperature of heat distribution system 210. In any of these embodiments, sensor 215 generates a sensor value that is indicative of the operating temperature or the power output (which is in turn related to the operating temperature) of inverse designed photonic component 205. Controller 220 is coupled to heat distribution system 210 and sensor 215 in a feedback loop configuration and includes feedback control logic to adjust the heating power output by heat distribution system 210 in response to the sensor value obtained from sensor 215.

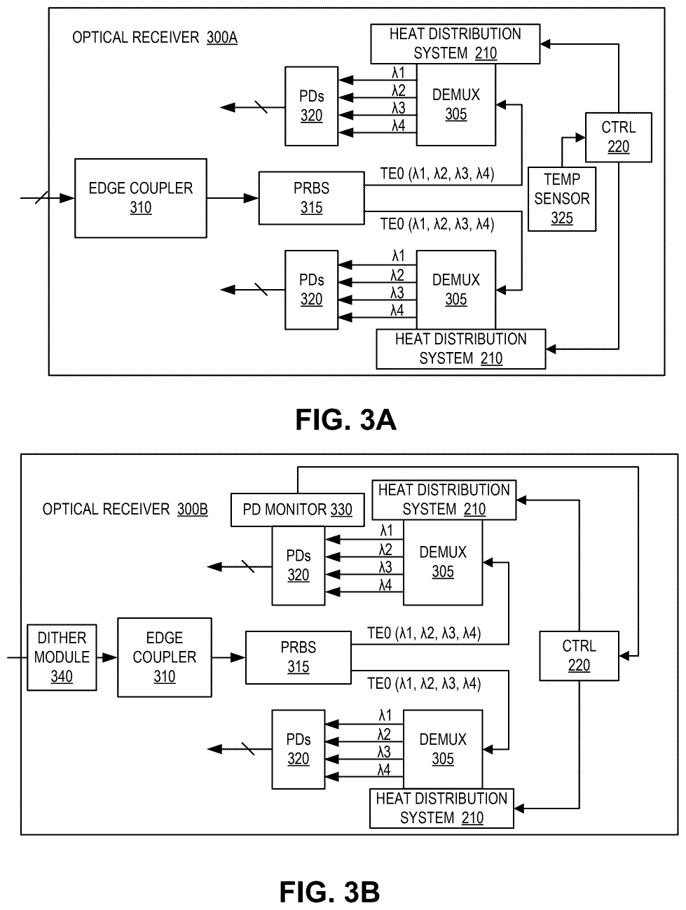

FIGS. 3A and 3B are functional block diagrams that illustrate example optical receivers 300A and 300B, respectively, which include thermally tuned/regulated demuxs 305. Optical receivers 300A and 300B represent example implementations of thermally regulated photonic system 200 while demuxs 305 represent example implementations of inverse designed photonic component 205. The components of optical receivers 300A or 300B may each be integrated within a PIC. The demultiplexing functionality of demuxs 305 may be implemented as an inverse designed 1×4 demultiplexer similar to that described in US Patent Publication No. 2023/0099485 A1, but with the addition of the heat distribution system and feedback loop configuration described herein. The contents of US Patent Publication No. 2023/0099485 A1 are hereby incorporated by reference.

Optical receiver 300A or B may be integrated into a silicon photonic optical transceiver. As illustrated, optical receiver 300A includes an edge coupler 310 that receives, amplifies, and/or filters input optical signals including multi-wavelength and multi-polarization signals. A polarization rotating and beam splitter (PRBS) 315 demultiplexes the transverse electric (TE) and transverse magnetic (TM) polarizations to respective physical ports while also rotating the TM polarization to the TE polarization.

The wavelength division multiplexed signals are then demultiplexed by demuxes 305 and converted from the optical to electrical realm by photodetectors 320.

In FIG. 3A the thermal regulation circuitry includes controller 220, heat distribution system 210, and a temperature sensor 325 connected in a feedback loop configuration. Controller 220 monitors the temperature of the PIC adjacent to demuxes 305 via temperature sensor 325. The sensor value (i.e., temperature reading) is used as a feedback signal for modulating one or more heaters or current drivers within heat distribution systems 210, which distribute heat to demuxes 305. In one embodiment, temperature sensor 325 is a metal-based resistor having a resistance dependent on temperature.

In FIG. 3B, the thermal regulation circuitry includes controller 220, heat distribution system 210, and photodiode (PD) monitors 330 (also referred to as a power sensor). Controller 220 monitors the power of PDs 320 via PD monitors 330. The optimal temperature may be associated with the greatest optical power received by PDs 320. Accordingly, optical power at PDs 320 is used as the feedback signal for modulating the heat output of heat distribution systems 210. In yet another embodiment, a dither module 340 may be positioned near the input of optical receiver 300B to apply a wavelength specific dither. This wavelength specific dither is then monitored downstream from demuxes 305 using the PD monitors 330 to measure the power associated with the wavelength specific dither at the output of optical receiver 300B. The power measurement of the wavelength specific dither is then used as the feedback control signal to controller 220 for driving the heaters/drivers of heat distribution systems 210.

Accordingly, in various embodiments, demuxes 305 within optical receivers 300A or 300B may be thermally tuned/regulated via a temperature feedback control (FIG. 3A), a total transmitted power feedback control (FIG. 3B omitting dither module 340), or a specific wavelength power feedback control (FIG. 3B with dither module 340). All three of these feedback control mechanisms may be an iterative and continuous control process. Furthermore, a trimming procedure may be applied after manufacturing to retarget the center wavelength of the manufactured inverse designed photonic component.

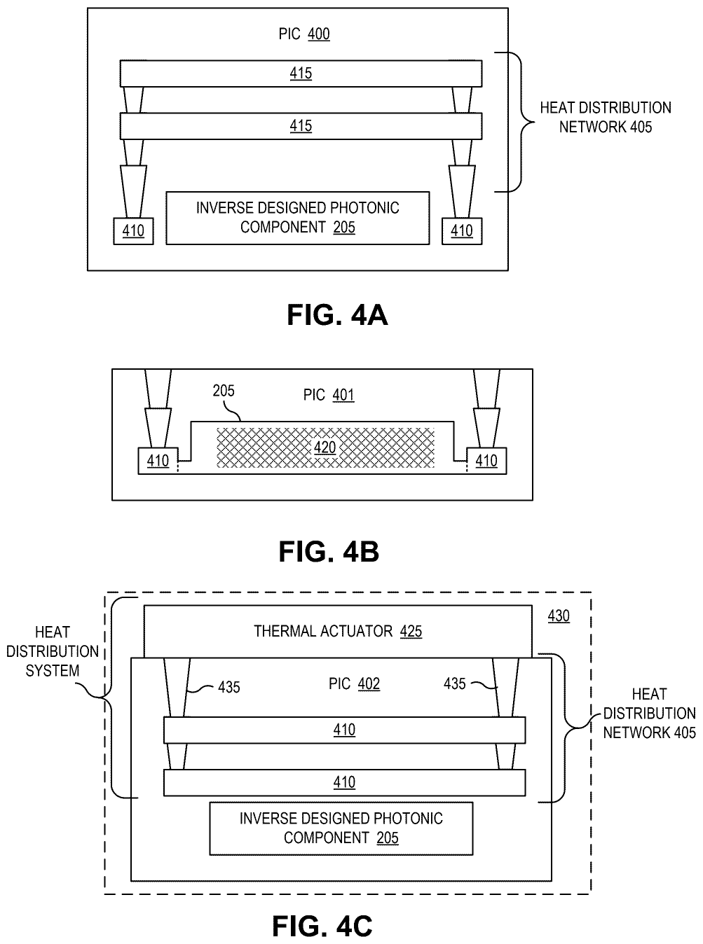

FIGS. 4A-C and 5A-G illustrate various details of embodiments of heat distribution system 210. The features illustrated in FIGS. 4A-C and 5A-G may be combined, in various combinations, into a single embodiment as well.

FIG. 4A is a cross-sectional illustration depicting a PIC 400 having an inverse designed photonic component 205 that is thermally regulated using a heat distribution system including heat distribution network 405 and one or more thermal actuators 410. The illustrated embodiment of heat distribution network 405 includes a network of paths 415 integrated into PIC 400. Although FIGS. 4A and 4C both illustrate heat distribution network 405 as having two layers of paths 415, it should be appreciated that paths 415 may reside entirely in a single stack layer or extend across several stacked layers. In one embodiment, paths 415 are implemented as electrically resistive heating elements (e.g., thin metal traces, semiconductor doped paths, etc.) while thermal actuators 410 are implemented as one or more current drivers or voltage sources that drive current through paths 415. In this embodiment, paths 415 operate as heating elements. In another embodiment, paths 415 are thermally conductive paths or “heat spreaders” (e.g., thicker metal traces) while thermal actuators 410 are implemented as heat sources (e.g., resistive heaters), which distribute their heat to inverse designed photonic component 205 via the thermally conductive paths 415. In yet another embodiment, both options may co-exist together. Accordingly, FIG. 4A illustrates embodiments where heat distribution network 405, thermal actuators 410, and inverse designed photonic component 205 are all integrated into PIC 400 and paths 415 run adjacent to inverse designed photonic component 205 to distribute heat thereto. In the illustrated embodiment of FIG. 4A, paths 410 are disposed in upper SOI layers of PIC 400 and run across a single side (e.g., top) of inverse designed photonic component 205; however, in other embodiments, paths 415 may be disposed in multiple layers of the SOI stack and spread or wrap around multiple sides of inverse designed photonic component 205.

FIG. 4B is a cross-sectional illustration depicting a PIC 401 with an inverse designed photonic component 205 having a heat distribution network 420 disposed within itself, in accordance with an embodiment of the disclosure. In other words, heat distribution network 420 may be incorporated directly into inverse designed photonic component 205. Inverse designed photonic component 205 may be formed from an inhomogeneous structured pattern of two materials having different refractive indexes while heat distribution network 420 is interspersed, intermingled, or otherwise intersects the inverse designed pattern of component 205. For example, inverse designed photonic component 205 may be a pattern of silicon and silicon dioxide while heat distribution network 420 is formed by doped silicon paths forming a network of electrically resistive paths within, adjacent to, and/or intersecting the pattern of silicon and silicon dioxide. The silicon and silicon dioxide form the photonic pattern (aka photonic floorplan) that implements the photonic component while the dopant paths form the electrical pattern (aka heating floorplan) for thermally regulating the temperature of the photonic component. The dopant paths may have a marginal or manageable direct impact on the refractive indices of the photonic structure while providing significant indirect influence over the refractive indices via thermal tuning. Of course, inverse designed photonic component 205 may be fabricated from other semiconductor materials than just silicon and silicon dioxide.

FIG. 4C is a cross-sectional illustration depicting a PIC 402 having an inverse designed photonic component 205 that is thermally regulated using a heat distribution system that is partially integrated into PIC 402 and partially external to PIC 402, in accordance with an embodiment of the disclosure. In the illustrated embodiment, PIC 402 and thermal actuator 425 are both disposed within a common chip package 430; however, thermal actuator 425 is disposed external to PIC 402 while paths 410 of heat distribution network 405 are integrated into PIC 402. As discussed above in connection with FIG. 4A, paths 410 may be implemented as thermally conductive heat spreaders or as electrically resistive heating elements and the externally disposed thermal actuator 425 may be implemented as a heater or a current/voltage driver. In one embodiment, thermal actuator 425 is mounted to an external surface of PIC 402 and surface bonded thereto. In an embodiment where thermal actuator 425 is a heater (e.g., resistive heater), thermal actuator 425 is thermally coupled to heat distribution network 405 using thermally conductive vias 435 (e.g., metal plugs or wells). In an embodiment where thermal actuator 425 is a current/voltage driver, thermal actuator 425 is electrically coupled to heat distribution network 405 using electrically conductive vias 435 (metal vias, doped wells, etc.).

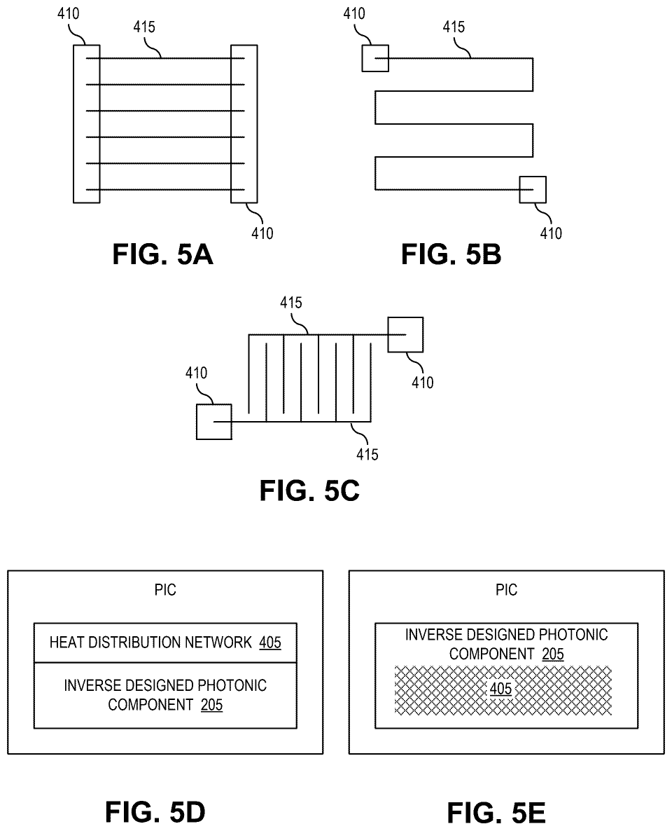

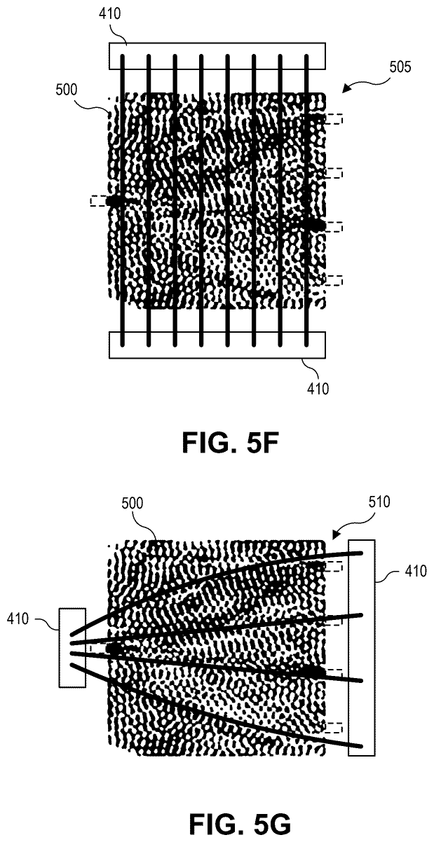

FIGS. 5A-C illustrate example routing patterns for heat distribution network 405, in accordance with an embodiment of the disclosure. FIGS. 4A-C are cross-sectional illustrations of heat distribution network 405 within PICs 400-402. In contrast, FIGS. 5A-C are plan view illustrations depicting example routing layouts or floorplans for paths 415. Paths 415 may be routed in a column/row/grid layout (e.g., FIG. 5A illustrates a row layout), a serpentine layout (FIG. 5B), an interdigitated layout (FIG. 5C), or assume a variety of other layout patterns. FIG. 5D is a cross-sectional illustration of how heat distribution network 405 may be disposed adjacent to an inverse designed photonic component 205 within a PIC while FIG. 5E illustrates that heat distribution network 405 may be disposed in the inverse designed photonic component 205 itself and weave about the photonic structure or even intersect portions of the photonic structure. When heat distribution network 405 is disposed within inverse designed photonic component 205, it may be doped into the photonic structure of inverse designed photonic component 205 as a specific pattern (e.g., any of the patterns illustrated in FIGS. 5A-C), form a blanket dopant pattern that turns the bulk semiconductor structure of inverse designed photonic component 205 into a single bulk resistive heating element, or follow another custom layout pattern that is dependent upon the photonic structure itself.

FIGS. 5F and 5G illustrate an inverse designed 1×4 demux 500 having example patterns of heat distribution networks disposed therein. In particular, FIG. 5F illustrates a heat distribution network 505 that is a doped column pattern where the electrically resistive dopant paths intersect with and pass through the optical paths in the photonic structure of the inverse designed 1×4 demux 500. FIG. 5G illustrates how the dopant paths of the heat distribution network 510 may follow portions of a pattern of the inverse designed photonic component (inverse designed 1×4 demux 500) that correlate to high optical energy density locations. In other words, the inhomogeneous arrangement of the two or more different materials having different refractive indexes (e.g., silicon and silicon dioxide) interact with the light passing through inverse designed 1×4 demux 500 causing different regions to have high and low optical energy densities. Routing the resistive dopants paths to follow, be coincident with, or run adjacent to the high energy density locations can increase the heating efficiency. The high energy density locations will often follow paths that snake between the input and output ports of inverse designed photonic component. The high energy density locations may be defined as regions having energy densities above a threshold level during operation.

Both component 205 and/or the heat distribution system 210 may be designed using inverse designed techniques. In particular, their respective electrical or photonic patterns may be inverse designed via interative minimization of a loss function. In the case of inverse designed photonic component 205, at least two materials having differing refractive indexes may be defined by an iterative minimization of a loss function that sums a transmission loss, a reflection loss, and a crosstalk loss. The optimization objective of the inverse design methodology may be constructed as a function of the following loss function Loss(x),

$$Loss ( x ) = {\sum }_{λ} Transmission loss ( x , λ ) + {\sum }_{λ} Reflection loss ( x , λ ) + {\sum }_{λ} Crosstalk loss ( x , λ ) ,$$

$$where ,$$

$$Transmission loss ( x , λ ) = {( Transmission ( x , λ ) - target values 1 )}^{2}$$

$$Reflection loss ( x , λ ) = {( Reflection ( x , λ ) - target values 2 )}^{2}$$

$$Crosstalk loss ( x , λ ) = {( Crosstalk ( x , λ ) - target values 3 )}^{2} .$$

The objective is constructed in a way that rewards the desired function while penalizing losses. The scattering-parameters (s-parameters) describing the desired behavior may be stipulated and populated into a s-matrix. In particular, the s-parameters within the s-matrix represent the target values for transmission (T), reflection (R), and crosstalk (C). Blank spaces in the s-matrix indicate “don't care” values that are not used as a target value in the loss function Loss(x).

Inverse design operates using a design simulator (aka design model) configured with an initial design or pattern for the photonic component to perform a forward operational simulation of the initial design (e.g., using Maxwell's equations for electromagnetics). For example, the initial design could be a random pattern of silicon and silicon dioxide. The output of the forward operational simulation is a simulated field response at output ports (e.g., output ports of a 1×4 demux) in response to stimuli at an input port. Specific performance parameters of this output field response may be selected as parameters of interest (e.g., power loss, wavelength, crosstalk, etc.) and are referred to as simulated performance parameters. The simulated performance parameters are used by the loss function to calculate a performance loss value, which may be a scalar value (e.g., mean square difference between simulated performance values and target values). The differentiable nature of the design model enables a backpropagation via an adjoint simulation of a performance loss error, which is the difference between the simulated output values and the desired/target performance values. The performance loss error is backpropagated through the design model during the adjoint simulation to generate structural gradients that represent, for example, the sensitivity of the performance loss value to changes in the structural material properties (e.g., topology or pattern of materials) of the design region. A program such as TensorFlow published by Google may be used to calculate the gradients. These gradients may then be used by a structural optimizer to optimize or refine the initial structural design to generate a revised structural design of the design region. The forward and reverse simulations may then be iterated along with the structural optimization (e.g., iterative gradient descent, stochastic gradient descent, etc.) until the performance loss value falls within acceptable design criteria (referred to as saturation) and/or for a predetermined number of iterations. The above description is merely an example inverse design technique that may be used to refine or optimize the features and topology of the pattern within inverse designed photonic component 205. It is appreciated that other inverse design techniques alone, or in combination with other conventional design techniques, may also be implemented.

The inverse design techniques described above may be applied to determine the specific material combinations, feature sizes, and feature arrangement (i.e., irregular pattern) to achieve the desired photonic function using the above loss function. Loss (x) is a function of x, where x is a vector representing the structural pattern of materials having different refractive indexes within inverse designed photonic component 205.

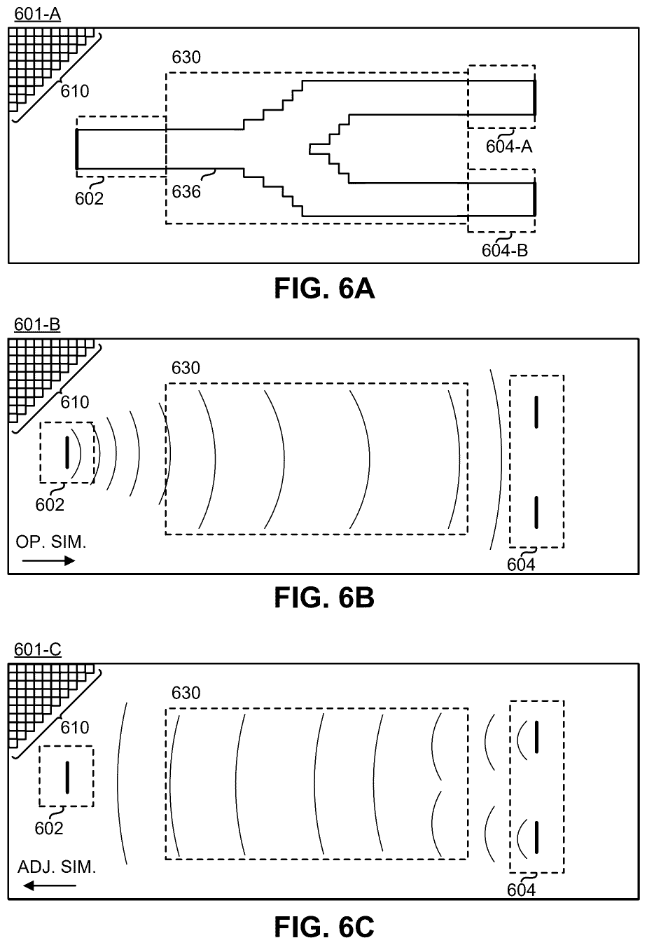

FIGS. 6A-6C respectively illustrate an initial set up of a simulated environment 601-A describing a photonic device (e.g., 1×2 demux), performing an operational simulation of the photonic device in response to an excitation source within the simulated environment 601-B, and performing an adjoint simulation of the photonic device within the simulated environment 601-C. As illustrated in FIGS. 6A-6C, simulated environment 601 is represented in two-dimensions. However, it is appreciated that other dimensionality (e.g., 3-dimensional space) may also be used to describe simulated environment 601 and the photonic device. In some embodiments, optimization of structural parameters of the photonic device illustrated in FIGS. 6A-6C may be achieved via an inverse design process including, inter alia, simulations (e.g., operational simulations and adjoint simulations) that utilize a finite-difference time-domain (FDTD) method to model the field response (e.g., electric and magnetic field) to an excitation source.

FIG. 6A illustrates a demonstrative simulated environment 601-A for inverse designing a photonic component into a PIC (i.e., a photonic component such as a, demultiplexer, multiplexer, and the like), in accordance with an embodiment of the present disclosure. More specifically, in response to receiving an initial description of the photonic component defined by one or more structural parameters (e.g., an input design), a simulated environment 601 is configured to be representative of the photonic component. As illustrated, the simulated environment 601 (and subsequently the photonic component) is described by a plurality of voxels 610, which represent individual elements (i.e., discretized) of the two-dimensional (or other dimensionality) space. Each of the voxels is illustrated as two-dimensional squares; however, it is appreciated that the voxels may be represented as cubes or other shapes in three-dimensional space. It is appreciated that the specific shape and dimensionality of the plurality of voxels 610 may be adjusted dependent on the simulated environment 601 and photonic component being simulated. It is further noted that only a portion of the plurality of voxels 610 are illustrated to avoid obscuring other aspects of the simulated environment 601.

Each of the plurality of voxels 610 may be associated with a structural value, a field value, and a source value. Collectively, the structural values of the simulated environment 601 describe the structural parameters of the photonic component. In one embodiment, the structural values may correspond to a relative permittivity, permeability, and/or refractive index that collectively describe structural (i.e., material) boundaries or interfaces of the photonic component. For example, an interface 636 is representative of where relative permittivity changes within the simulated environment 601 and may define a boundary of the photonic component where a first material meets or otherwise interfaces with a second material. The field value describes the field (or loss) response that is calculated (e.g., via Maxwell's equations) in response to an excitation source described by the source value. The field response, for example, may correspond to a vector describing the electric and/or magnetic fields (e.g., in one or more orthogonal directions) at a particular time step for each of the plurality of voxels 610. Thus, the field response may be based, at least in part, on the structural parameters of the photonic component and the excitation source.

In the illustrated embodiment, the photonic component corresponds to an optical demultiplexer having a design region 630, in which structural parameters of the photonic device may be updated or otherwise revised. More specifically, through an inverse design process, iterative gradient-based optimization of a loss metric determined from a loss function is performed to generate a design of the photonic component that functionally causes a multi-channel optical signal to be demultiplexed and guided from input port 602 to a corresponding one of the output ports 604. Thus, input port 602 of the photonic component corresponds to a location of an excitation source to provide an output (e.g., a Gaussian pulse, a wave, a waveguide mode response, and the like). The output of the excitation source interacts with the photonic component based on the structural parameters (e.g., an electromagnetic wave corresponding to the excitation source may be perturbed, retransmitted, attenuated, refracted, reflected, diffracted, scattered, absorbed, dispersed, amplified, or otherwise as the wave propagates through the photonic component within simulated environment 601). In other words, the excitation source may cause the field response of the photonic component to change, which is dependent on the underlying physics governing the physical domain and the structural parameters of the photonic component. The excitation source originates or is otherwise proximate to input port 602 and is positioned to propagate (or otherwise influence the field values of the plurality of voxels) through the design region 630 towards output ports 604 of the photonic component. In the illustrated embodiment, the input port 602 and output ports 604 are positioned outside of the design region 630. In other words, in the illustrated embodiment, only a portion of the structural parameters of the photonic component is optimizable.

However, in other embodiments, the entirety of the photonic component may be placed within the design region 630 such that the structural parameters may represent any portion or the entirety of the design of the photonic component. The electric and magnetic fields within the simulated environment 601 (and subsequently the photonic component) may change (e.g., represented by field values of the individual voxels that collectively correspond to the field response of the simulated environment) in response to the excitation source. The output ports 604 of the optical demultiplexer may be used for determining a performance metric of the photonic component in response to the excitation source (e.g., power transmission from input port 602 to a specific one of the output ports 604.). The initial description of the photonic component, including initial structural parameters, excitation source, performance parameters or metrics, and other parameters describing the photonic component, are received by the simulation system and used to configure the simulated environment 601 for performing a first-principles based simulation of the photonic component. These specific values and parameters may be defined directly by a user.

FIG. 6B illustrates an operational simulation of the photonic component in response to an excitation source within simulated environment 601-B, in accordance with an embodiment of the present disclosure. In the illustrated embodiment, the photonic component is an optical demultiplexer structured to optically separate each of a plurality of distinct wavelength channels included in a multi-channel optical signal received at input port 602 and respectively guide each of the plurality of distinct wavelength channels to a corresponding one of the plurality of output regions 604. The excitation source may be selected (randomly or otherwise) from the plurality of distinct wavelength channels and originates at input region 602 having a specified spatial, phase, and/or temporal profile. The operational simulation occurs over a plurality of time steps, including the illustrated time step. When performing the operational simulation, changes to the field response (e.g., the field value) for each of the plurality of voxels 610 are incrementally updated in response to the excitation source over the plurality of time steps. The changes in the field response at a particular time step are based, at least in part, on the structural parameters, the excitation source, and the field response of the simulated environment 601 at the immediately prior time step included in the plurality of time steps. Similarly, in some embodiments the source value of the plurality of voxels 610 is updated (e.g., based on the spatial profile and/or temporal profile describing the excitation source). It is appreciated that the operational simulation is incremental and that the field values (and source values) of the simulated environment 601 are updated incrementally at each time step as time moves forward for each of the plurality of time steps during the operational simulation. It is further noted that in some embodiments, the update is an iterative process and that the update of each field and source value is based, at least in part, on the previous update of each field and source value.

Once the operational simulation reaches a steady state (e.g., changes to the field values in response to the excitation source substantially stabilize or reduce to negligible values) or otherwise concludes, one or more performance metrics may be determined. In one embodiment, the performance metric corresponds to the power transmission at a corresponding one of the output ports 604 mapped to the distinct wavelength channel being simulated by the excitation source. In other words, in some embodiments, the performance metric represents power (at one or more frequencies of interest) in the target mode shape at the specific locations of the output ports 604. A loss value or metric of the input design (e.g., the initial design and/or any refined design in which the structural parameters have been updated) based, at least in part, on the performance metric may be determined via a loss function. The loss metric, in conjunction with an adjoint simulation, may be utilized to determine a structural gradient (e.g., influence of structural parameters on loss metric) for updating or otherwise revising the structural parameters to reduce the loss metric (i.e. increase the performance metric). It is noted that the loss metric is further based on a fabrication loss value that is utilized to enforce a minimum feature size of the photonic device to promote fabricability of the component.

FIG. 6C illustrates an example adjoint simulation within simulated environment 601-C by backpropagating a loss metric, in accordance with an embodiment of the present disclosure. More specifically, the adjoint simulation is a time-backwards simulation in which a loss metric is treated as an excitation source that interacts with the photonic device and causes a loss response. In other words, an adjoint (or virtual source) based on the loss metric is placed at the output region (e.g., output ports 604) or other location that corresponds to a location used when determining the performance metric. The adjoint source(s) is then treated as a physical stimuli or an excitation source during the adjoint simulation. A loss response of the simulated environment 601 is computed for each of the plurality of time steps (e.g., backwards in time) in response to the adjoint source. The loss response collectively refers to loss values of the plurality of voxels that are incrementally updated in response to the adjoint source over the plurality of time steps. The change in loss response based on the loss metric may correspond to a loss gradient, which is indicative of how changes in the field response of the photonic component influence the loss metric. The loss gradient and the field gradient may be combined in the appropriate way to determine a structural gradient of the photonic device/simulated environment (e.g., how changes in the structural parameters of the photonic component within the simulated environment influence the loss metric). Once the structural gradient of a particular cycle (e.g., operational and adjoint simulation) is known, the structural parameters may be updated to reduce the loss metric and generate a revised description or design of the photonic device.

In some embodiments, iterative cycles of performing the operational simulation, and adjoint simulation, determining the structural gradient, and updating the structural parameters to reduce the loss metric are performed successively as part of an inverse design process that utilizes iterative gradient-based optimization. An optimization scheme such as gradient descent may be utilized to determine specific amounts or degrees of changes to the structural parameters of the photonic component to incrementally reduce the loss metric. More specifically, after each cycle the structural parameters are updated (e.g., optimized) to reduce the loss metric. The operational simulation, adjoint simulation, and updating the structural parameters are iteratively repeated until the loss metric substantially converges or is otherwise below or within a threshold value or range such that the photonic device provides the desired performance while maintaining fabricability.

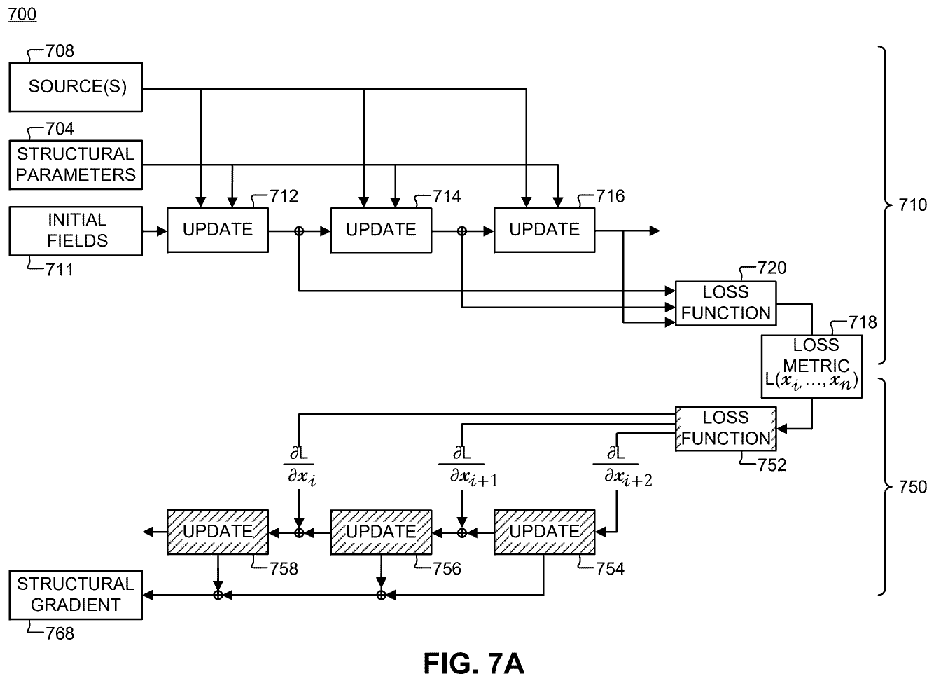

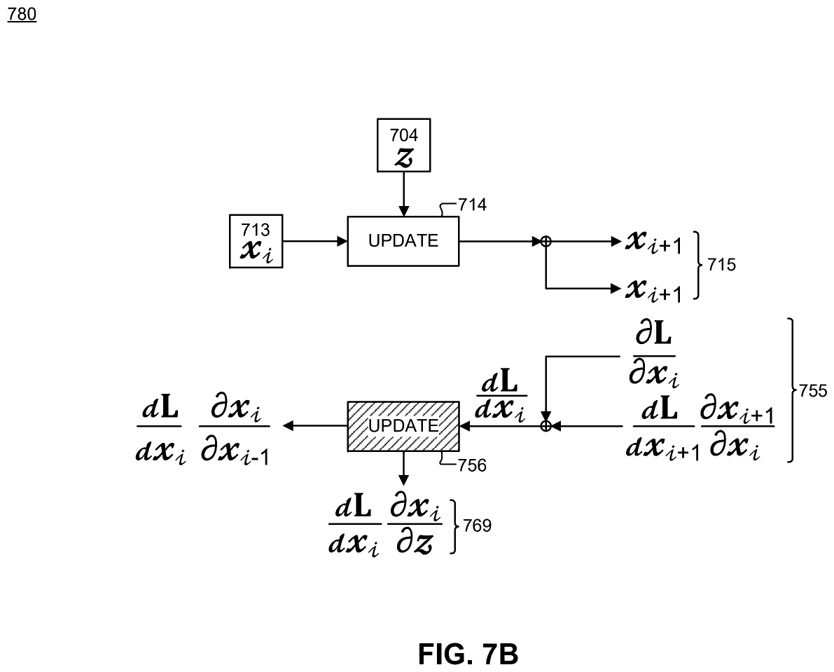

FIG. 7A is a flow chart 700 illustrating example time steps for the operational simulation 710 and adjoint simulation 750, in accordance with an embodiment of the present disclosure. Flow chart 700 explains how to perform the operational simulation 710 and adjoint simulation 750 of the simulated environment (e.g., simulated environment 601 of FIGS. 6A-6C) describing a photonic integrated circuit (e.g., an optical device operating in an electromagnetic domain such as a photonic demultiplexer). In the illustrated embodiment, the operational simulation utilizes a finite-difference time-domain (FDTD) method to model the field response (both electric and magnetic) or loss response at each of a plurality of voxels (e.g., plurality of voxels 610 illustrated in FIGS. 6A-6C) for a plurality of time steps in response to physical stimuli corresponding to an excitation source and/or adjoint source.

As illustrated in FIG. 7A, the flow chart 700 includes update operations for a portion of operational simulation 710 and adjoint simulation 750. Operational simulation 710 occurs over a plurality of time-steps (e.g., from an initial time step to a final time step over a pre-determined or conditional number of time steps having a specified time step size) and models changes (e.g., from the initial field values 711) in electric and magnetic fields of a plurality of voxels describing the simulated environment and/or photonic device that collectively correspond to the field response. More specifically, update operations (e.g., 712, 714, and 716) are iterative and based on the field response, structural parameters 704, and one or more excitation sources 708. Each update operation is succeeded by another update operation, which are representative of successive steps forward in time within the plurality of time steps. For example, update operation 714 updates the field values 713 (see, e.g., FIG. 7B) based on the field response determined from the previous update operation 712, sources 708, and the structural parameters 704. Similarly, update operation 716 updates the field values 715 (see, e.g., FIG. 7B) based on the field response determined from update operation 714. In other words, at each time step of the operational simulation the field values (and thus field response) are updated based on the previous field response and structural parameters of the photonic component. Once the final time step of the operational simulation 710 is performed, the loss metric 718 may be determined (e.g., based on a pre-determined loss function 720). The loss gradients determined from block 752 may be treated as adjoint or virtual sources (e.g., physical stimuli or excitation source originating at an output region or port) which are backpropagated in reverse (from the final time step incrementally through the plurality of time steps until reaching the initial time step) to determine structural gradient 768.

In the illustrated embodiment, the FDTD solve (e.g., operational simulation 710) and backward solve (e.g., adjoint simulation 750) problem are described pictorially, from a high-level, using only “update” and “loss” operations as well as their corresponding gradient operations. The simulation is set up initially in which the structural parameters, physical stimuli (i.e., excitation source), and initial field states of the simulated environment (and photonic device) are provided (e.g., via an initial description and/or input design). As discussed previously, the field values are updated in response to the excitation source based on the structural parameters. More specifically, the update operation is given by ϕ, where [symbol] =ϕ [symbol] , [symbol] , [symbol] ) for [symbol] =1, . . . [symbol] . Here, [symbol] corresponds to the total number of time steps (e.g., the plurality of time steps) for the operational simulation, where [symbol] corresponds to the field response (the field value associated with the electric and magnetic fields of each of the plurality of voxels) of the simulated environment at time step [symbol] , [symbol] corresponds to the excitation source(s) (the source value associated with the electric and magnetic fields for each of the plurality of voxels) of the simulated environment at time step [symbol] , and [symbol] corresponds to the structural parameters describing the topology and/or material properties of the photonic device (e.g., relative permittivity, index of refraction, and the like).

It is noted that using the FDTD method, the update operation may specifically be stated as:

$$ϕ ( {x}_{i} , {b}_{i} , z ) = A ( z ) {x}_{i} + B ( z ) {b}_{i} . \qquad ( 1 )$$

That is to say the FDTD update is linear with respect to the field and source terms. Concretely, A ( [symbol] )∈ [symbol] ^{N×N} and B( [symbol] )∈ [symbol] ^{N×N} are linear operators which depend on the structure parameters, [symbol] , and act on the fields, [symbol] , and the sources, [symbol] , respectively. Here, it is assumed that [symbol] , [symbol] ∈ [symbol] ^{N} where N is the number of FDTD field components in the operational simulation. Additionally, the loss operation (e.g., loss function) may be given by L=f( [symbol] , . . . , [symbol] ), which takes as input the computed fields and produces a single, real-valued scalar (e.g., the loss metric) that can be reduced and/or minimized.

In terms of revising or otherwise optimizing the structural parameters of the photonic device, the relevant quantity to produce is dL/ [symbol] , which is used to describe the influence of changes in the structural parameters on the loss value and is denoted as the structural gradient 768 illustrated in FIG. 7A.

FIG. 7B is a chart 780 illustrating the relationship between the update operation for the operational simulation and the adjoint simulation (e.g., backpropagation), in accordance with an embodiment of the present disclosure. More specifically, FIG. 7B summarizes the operational and adjoint simulation relationships that are involved in computing the structural gradient, dL/ [symbol] , which include ∂L/ [symbol] , [symbol] /∂xᵢ, dL/ [symbol] , and [symbol] / [symbol] . The update operation 714 of the operational simulation updates the field values 713, az xᵢ, of the plurality of voxels at the ith time step to the next time step (i.e., [symbol] +1 time step), which correspond to the field values 715, [symbol] . The gradients 755 are utilized to determine dL/ [symbol] for the backpropagation (e.g., update operation 756 backwards in time), which combined with the gradients 769 are used, at least in part, to calculate the structural gradient, dL/ [symbol] , ∂L/ [symbol] is the contribution of each field to the loss metric, L. It is noted that this is the partial derivative, and therefore does not take into account the causal relationship of [symbol] → [symbol] . Thus, [symbol] / [symbol] is utilized which encompasses the [symbol] → [symbol] relationship. The loss gradient, dL/ [symbol] may also be used to compute the structural gradient, dL/ [symbol] and corresponds to the total derivative of the field with respect to loss value, L. The loss gradient, dL/dxᵢ, at a particular time step, i, is equal to the summation of ∂L/ [symbol] +dL/ [symbol] [symbol] / [symbol] . Finally, [symbol] /∂z, which corresponds to the field gradient, is used which is the contribution to dL/ [symbol] from each time/update step.

In particular, the memory footprint to directly compute ∂L/ [symbol] and dL/ [symbol] is so large that it is difficult to store more than a handful of state Tensors. The state Tensor corresponds to storing the values of all of the FDTD cells (e.g., the plurality of voxels) for a single simulation time step. It is appreciated that the term “tensor” may refer to tensors in a mathematical sense or as described by the TensorFlow framework developed by Alphabet, Inc. In some embodiments the term “tensor” refers to a mathematical tensor which corresponds to a multidimensional array that follows specific transformation laws. However, in most embodiments, the term “tensor” refers to TensorFlow tensors, in which a tensor is described as a generalization of vectors and matrices to potentially higher dimensions (e.g., n-dimensional arrays of base data types), and is not necessarily limited to specific transformation laws. For example, for the general loss function ƒ, it may be necessary to store the fields, [symbol] , for all time steps, [symbol] . This is because, for most choices of ƒ, the gradient will be a function of the arguments of ƒ. This difficulty is compounded by the fact that the values of ∂L/ [symbol] for larger values of [symbol] are needed before the values for smaller i due to the incremental updates of the field response and/or through backpropagation of the loss metric, which may prevent the use of schemes that attempt to store only the values ∂L/ [symbol] , at an immediate time step.

An additional difficulty is further illustrated when computing the structural gradient, dL/ [symbol] , which is given by:

$$\frac{dL}{dz} = {\sum }_{i} \frac{dL}{{dx}_{i}} \frac{\partial {x}_{i}}{\partial z} . \qquad ( 2 )$$

For completeness, the full form of the first term in the sum, dL/ [symbol] , is expressed as:

$$\frac{dL}{d {x}_{i}} = \frac{\partial L}{\partial {x}_{i}} + \frac{dL}{{dx}_{i + 1}} \frac{\partial {x}_{i + 1}}{\partial {x}_{i}} . \qquad ( 3 )$$

Based on the definition of ϕ as described by equation (1), it is noted that [symbol] / [symbol] =A( [symbol] ), which can be substituted in equation (3) to arrive at an adjoint update for backpropagation (e.g., the update operations such as update operation 756), which can be expressed as:

$$\frac{dL}{{dx}_{i}} = \frac{\partial L}{\partial {x}_{i}} + \frac{dL}{{dx}_{i + 1}} A ( z ) , \qquad ( 4 )$$

$$or$$

$${∇}_{{x}_{i}} L = {A ( z )}^{T} {∇}_{{x}_{i + 1}} L + \frac{\partial {L}^{T}}{\partial {x}_{i}} . \qquad ( 5 )$$

The adjoint update is the backpropagation of the loss gradient (e.g., from the loss metric) from later to earlier time steps and may be referred to as a backwards solve for dL/ [symbol] . More specifically, the loss gradient may initially be based upon the backpropagation of a loss metric determined from the operational simulation with the loss function. The second term in the sum of the structural gradient, dL/ [symbol] , corresponds to the field gradient and is denoted as:

$$\frac{\partial {x}_{i}}{\partial z} = \frac{d ϕ ( {x}_{i - 1} , {b}_{i - 1} , z )}{dz} = \frac{dA ( z )}{dz} {x}_{i - 1} + \frac{dB ( z )}{dz} {b}_{i - 1} , \qquad ( 6 )$$

for the particular form of ϕ described by equation (1). Thus, each term of the sum associated dL/ [symbol] depends on both

$$\frac{dL}{{dx}_{{i}_{0}}}$$

for [symbol] >= [symbol] and [symbol] for [symbol] < [symbol] . Since the dependency chains of these two terms are in opposite directions, it is concluded that computing dL/ [symbol] in this way requires the storage of [symbol] values for all of [symbol] . In some embodiments, the need to store all field values may be mitigated by a reduced representation of the fields.

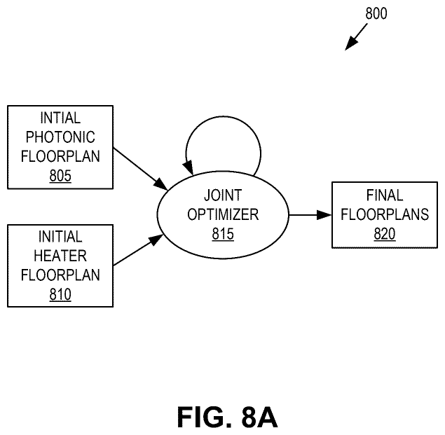

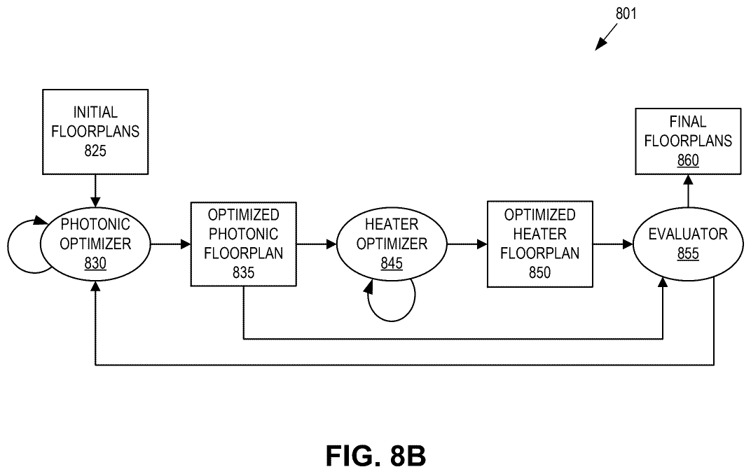

FIGS. 8A and 8B illustrate various options for inversely designing/optimizing a photonic floorplan for inverse designed photonic component 205 and a heater floorplan for heat distribution system 210, in accordance with embodiments of the disclosure. In particular, FIG. 8A is a flow chart 800 illustrating how an initial photonic floorplan 805 and initial heater floorplan 810 may be both fed into a joint optimizer 815 and then iteratively and jointly inversely optimized together to generate final floorplans 820, in accordance with an embodiment of the present disclosure. The photonic floorplan describes the permittivity values of each voxel within its design space while the heater floorplan describes electrode locations, heater design, dopant paths, heat spreaders, peripheral contacts, and/or the like. The loss function Joint Loss(x) may be defined as a worst-case condition for electrical consumption (e.g., determined by the lowest expected ambient temperature) and defined as:

$$Joint Loss ( x ) = \sum Transmission loss ( x , λ ) + \sum Reflection loss ( x , λ ) + \sum Crosstalk loss ( x , λ ) + \sum Heater Power Efficiency ( x , λ ) + \sum Resistance ( x , λ ) + \sum Heating Uniformity ( x , λ ) , \qquad ( 7 )$$

where,

Transmission loss(x,λ)=(Transmission(x,λ)−target values1)²,

Reflection loss(x,λ)=(Reflection(x,λ)−target values2)²,

Crosstalk loss(x,λ)=(Crosstalk(x,λ)−target values3)²,

Heater Power Efficiency(x,λ)=(Power Consumption(x,λ)−target values4)²,

Resistance(x,λ)=(Resistance(x,λ)−target values5)²,

Heating Uniformity(x,λ)=(Heating(x,λ)−target values6)², and

x is a vector representing the structural pattern of materials having different refractive indexes, resistances, thermal conductivity, etc. within photonic floorplan 805 and heater floorplan 810. Accordingly, both inverse designed photonic component 205 and heat distribution system 210 may be inversely designed together.

FIG. 8B is a flow chart 801 illustrating how the photonic floorplan of the inverse designed photonic component 205 and the heater floorplan of heat distribution system 210 may be separately but sequentially optimized, in accordance with an embodiment of the present disclosure. As illustrated, the initial photonic and heater floorplans 825 may be fed into a photonic optimizer 830 that only optimizes the photonic floorplan, using loss function Photonic Loss(x):

$$Photonic Loss ( x ) = \sum Transmission loss ( x , λ ) + \sum Reflection loss ( x , λ ) + \sum Crosstalk loss ( x , λ ) . \qquad ( 8 )$$

After creation of an optimized photonic floorplan 835, it along with the initial heater floorplan are fed into a heater optimizer 845 to generate an optimized heater floorplan 850 using loss function Heater Loss(x):

$$Heater Loss ( x ) = \sum Heater Power Efficiency ( x , λ ) + \sum Resistance ( x , λ ) + \sum Heating Uniformity ( x , λ ) \qquad ( 9 )$$

In one embodiment, the generation of optimized heater floorplan 850 is assumed to have negligible impact on optimized photonic floorplan 835 and thus represents the completion of the sequential optimizations of inverse designed photonic component 205 and its heat distribution system 210. In this embodiment, heater optimizer 845 is restricted to a design space that doesn't substantially affect the optical operation of optimized photonic floorplan 835. In other embodiments, the impact of the heater optimizer on the optimized photonic floorplan 835 may be simulated by evaluator 855. If optimized photonic floorplan 835 still meets its design criteria, then the optimized photonic and heater floorplans are output as the final floorplans 860. However, if optimized photonic floorplan 835 no longer meets its design criteria, then the optimized floorplans are input back into photonic optimizer 830 for another round of iterative optimization of the photonic floorplan.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A thermally regulated photonic system, comprising:
a photonic component;
a sensor adapted to measure a temperature related to the photonic component or a power output of the photonic component and generate a sensor value that is indicative of the temperature or the power output;
a heat distribution system thermally coupled to the photonic component and adapted to generate and distribute heat to the photonic component; and
a controller coupled to the sensor and the heat distribution system in a feedback loop configuration to thermally regulate the photonic component based upon the sensor value.

2. The thermally regulated photonic system of claim 1, wherein the heat distribution system comprises a network of thermally conductive paths or a network of electrically resistive paths that run adjacent to or through the photonic component.

3. The thermally regulated photonic system of claim 2, wherein the heat distribution system includes the network of thermally conductive paths configured as heat spreaders and one or more heaters thermally coupled to the network of thermally conductive paths.

4. The thermally regulated photonic system of claim 3, wherein the photonic component and the network of thermally conductive paths are integrated into a single photonic integrated circuit (PIC) while the one or more heaters are disposed external to the PIC and thermally coupled to the network of thermally conductive paths via one or more thermally conductive vias.

5. The thermally regulated photonic system of claim 3, wherein the photonic component, the network of thermally conductive paths, and the one or more heaters are integrated into a single photonic integrated circuit (PIC).

6. The thermally regulated photonic system of claim 2, wherein the heat distribution system includes the network of electrically resistive paths and one or more drivers are electrically coupled to the network of electrically resistive paths to drive a current through the network of electrically resistive paths to generate the heat.

7. The thermally regulated photonic system of claim 6, wherein the photonic component, the network of electrically resistive paths, and the one or more drivers are integrated into a single photonic integrated circuit (PIC).

8. The thermally regulated photonic system of claim 6, wherein the photonic component comprises an inverse designed pattern of silicon and silicon dioxide and the network of electrically resistive paths comprise one or more doped silicon paths.

9. The thermally regulated photonic system of claim 8, wherein the one or more doped silicon paths are disposed in the inverse designed pattern of silicon and silicon dioxide of the photonic component.

10. The thermally regulated photonic system of claim 9, wherein the one or more doped silicon paths comprise a blanket dopant pattern disposed in the photonic component.

11. The thermally regulated photonic system of claim 8, wherein the one or more doped silicon paths follow portions of the inverse designed pattern of silicon and silicon dioxide that correlate to high optical energy density locations during operation of the photonic component.

12. The thermally regulated photonic system of claim 8, wherein the photonic component comprises an inverse designed photonic component and the network of electrically resistive paths comprises an inverse designed heat distribution network.

13. The thermally regulated photonic system of claim 1, wherein the photonic component comprises an inverse designed optical multiplexer or an inverse designed optical demultiplexer.

14. The thermally regulated photonic system of claim 1, further comprising:
a dither module adapted to apply a wavelength specific dither to an input optical signal of the photonic component, wherein the sensor is adapted to measure the power output associated with the wavelength specific dither.

15. A method of operation of a thermally regulated photonic system, the method comprising:
manipulating an optical signal with an inverse designed photonic component;
generating a sensor value that is indicative of a temperature related to the inverse designed photonic component or a power output of the inverse designed photonic component; and
thermally regulating the inverse designed photonic component via a heat distribution network thermally coupled to the inverse designed photonic component based upon the sensor value.

16. The method of claim 15, wherein the heat distribution network comprises thermally conductive paths or electrically resistive paths that run adjacent to or through the inverse designed photonic component.

17. The method of claim 16, wherein the heat distribution network comprises an inverse designed heat distribution network that is co-optimized with iterative optimizations of the inverse designed photonic component.

18. The method of claim 16, wherein thermally regulating the inverse designed photonic component comprises:
driving current through the electrically resistive paths of the heat distribution network,
wherein the inverse designed photonic component comprises a pattern of silicon and silicon dioxide and the network of electrically resistive paths comprise one or more doped silicon paths integrated with the pattern of silicon and silicon dioxide in a photonic integrated circuit.

19. The method of claim 18, wherein the one or more doped silicon paths comprise a blanket dopant pattern integrated with the inverse designed photonic component.

20. The method of claim 18, wherein the one or more doped silicon paths follow portions of the pattern of silicon and silicon dioxide that correlate to high optical energy density locations during operation of the inverse designed photonic component.

21. The method of claim 15, wherein manipulating the optical signal with the inverse designed photonic component comprises multiplexing or demultiplexing the optical signal.
